(19) United States
(12) Patent Application Publication
(10) Pub. No.: US 2009/0205626 A1
(43) Pub. Date: Aug. 20, 2009

(54) Grill for cooking

(76) Inventor: Francisco Jose Ferreiro Cerceda, Lugo (ES)

Correspondence Address: WENDEROTH, LIND & PONACK, L.L.P., 1030 15th Street, N.W.,, Suite 400 East, Washington, DC, 20005-1503, US

(21) Appl. No.: 12/292,036

(22) Filed: Nov. 10, 2008

(30) Foreign Application Priority Data
Nov. 8, 2007 (ES) P200702970

(51) Int. Cl. A47J 37/07; F24C 15/00

(52) U.S. Cl. 126/25 A; 126/299 R

(57) ABSTRACT

It relates to a grill intended for grilling meat and other products, and for making paellas and any other dishes, essentially used for large gastronomic events.

It is characterized in that it comprises in principle a lower base with legs and an upper grating which bears the different foods to cook, in such a way that the upper grating is attached to the base via means that permit the height of said grating to be regulated at any time in order to obtain greater or lesser heat for the products being cooked.

### OBJECT OF THE INVENTION

As stated in the title of this descriptive specification, the present invention relates to a grill for cooking essentially intended for use in gastronomic events, hotels, restaurants, exhibitions, parties and events involving the gathering of people.

It is therefore preferably a grill of large dimensions in which different foods can be grilled (cooked), above all meats, poultry, sausages, seafood, vegetables, fish, paellas and other foods.

It can also be stated that the grill can be used for preparing paellas and other cooked dishes, though it will preferably be used for grilling meat.

Starting from this premise, the essential objective of the invention concerns certain means for regulating the distance in height of the grill with respect to the embers so that at any moment the heat that is required is obtained for the product being grilled or cooked at that precise moment, along with the convenience that is created for the cook by the absence of obstacles, since the grill is moved with scarcely any effort so that the cook does not have to be in the zone of the heat, and therefore hardly having to move or change position. These movements of the grill can be manual or mechanical.

### BACKGROUND OF THE INVENTION

There currently exist different grills for the grilling of foods, with the heat being provided by means of coal embers, wood, gas and other combustible elements, in such a way that among these grills one can emphasize those that possess legs (a central shaft) for maintaining a certain distance between the embers and the grill.

A fixed distance between the grill and the embers is a drawback since during the cooking of the food borne on the grill, a greater or lesser heat might be needed at certain moments, or it might also be necessary to remove the food so that it does not become over-cooked, with the heat being able to be regulated in an uncomfortable way by acting on the embers or adding more wood, in which case it would become necessary to move the grill thereby interrupting the cooking process.

### DESCRIPTION OF THE INVENTION

With the aim of achieving the objectives and avoiding the drawbacks mentioned in the previous sections, the invention discloses a grill for cooking characterized in that it comprises in principle a lower base with support legs and an upper grating constituting the actual grill which is attached to the base via its center, with the important characteristic of being adjustable in height so that the heat of the embers on the product to be cooked can be intensified or reduced, simply by moving the upper grating further away or closer by positioning it in different horizontal planes. It can be emphasized that this system permits the food to be moved to a zone of less heat without any need to touch it directly, in order to prevent it from becoming overcooked and in the same way to maintain an optimum temperature until it is eaten.

The means of attachment and regulation in height of the upper grating consist of a threaded rod which projects perpendicularly from the center of the grating while at the same time this rod is coupled to a threaded hole also located in the center of the lower base, though, instead of a threaded rod, a smooth, pneumatic or hydraulic rod can also be used, which rod alters the height of the upper grating in relation to the lower grating or base. Said rod is linked to the upper grating by means of a horizontal bearing permitting the upper grating to turn in both directions.

In order to be able to turn the grating comfortably, and thereby vary its distance with respect to the embers and the lower base, provision has been made for some devices by means of radial handles provided around the edge of the grating, in the manner of a horizontal helm.

The grating and the base of the grill present an essentially circular configuration, though their shape could be any other: square, hexagonal, octagonal, etc.

Moreover, the grill of the invention has been provided with certain accessories, one of them consisting of an additional upper disc that can be attached to the rest of the grill by means of a central bar and which permits food to be kept hot while the cooking is continued on the grating; this additional upper disc having a diameter less than or equal to that of the said grating. Another of these accessories consists of a hood which facilitates the extraction of smoke and prevents particles in the air from falling onto the food. The grill of the invention furthermore comprises an accessory consisting of a lateral screen running from part of the perimeter of the lower base as far as ground, being situated in a zone where the air reaches from the outside, thereby protecting the cook from the heat.

Among others, the advantages of the novel grill are the following:
The circular configuration of the grill substantially facilitates its maneuverability, and it can be handled by just one person, both during its use when some product is being cooked and for loading it into a vehicle or for transporting it, in this case with the base and the grating being arranged separately in vertical planes so that both elements can be rolled comfortably with a minimum effort.
It is easy to dismantle.
It takes up very little space.
It is very pleasant to look at.
It is easy to clean owing to its easy mobility and dismantling.
Thanks to the coupling between the two essential parts of the grill, the grating will be arranged by rotating it in the appropriate direction or by mechanically raising or lowering it in a higher plane in order to leave enough space for being able to add more coal or wood when required.
A semicircular zone with heat can be prepared and another without heat so that the most cooked foods can be placed in the zone without heat in order to prevent these foods from becoming overcooked such that they cannot afterwards be eaten. This is the most usual way of using it, without detriment to being able to use it wholly or partially charged with fuel according to the user's needs.
Another characteristic of the invention relates to a plate with a flat surface that can be provided on the grating and which is used, for example, for cutting and preparing the food.
Another plate can also be incorporated with a structure of a grating that is thicker than the rest of the main grating so that smaller items of foods can be arranged on it in the manner of a griddle. The grating can also rest on small stones or wedges.

Below, in order to facilitate a better understanding of this descriptive specification and forming an integral part thereof, some figures are attached in which the object of the invention has been represented by way of 30 illustration and non-limiting.

### BRIEF DESCRIPTION OF THE DRAWINGS

FIG. 1.—Shows a view in exploded perspective of the grill for cooking, forming the object of the invention.

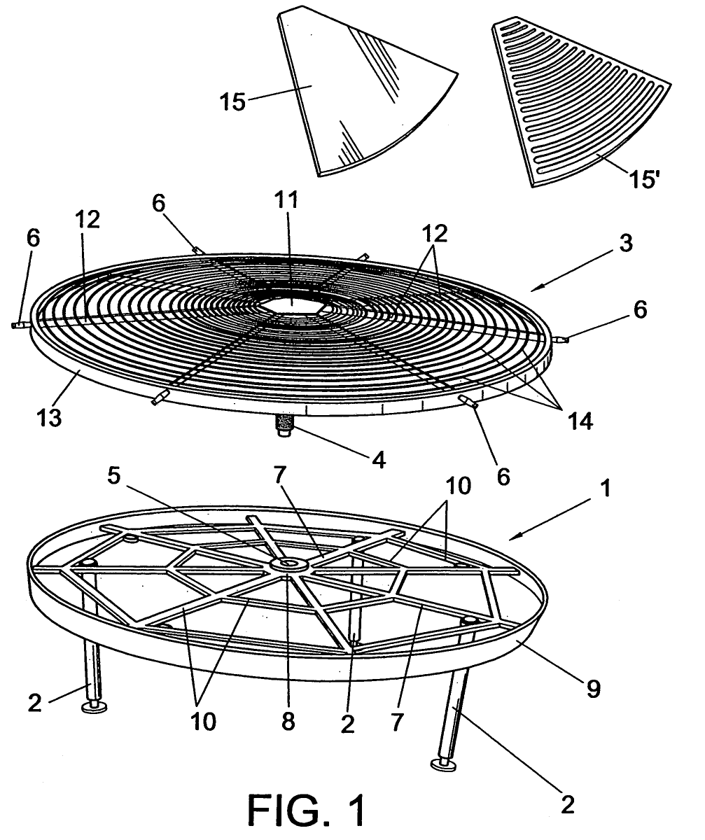

FIG. 2.—Shows a view in elevation of the grill of the invention.

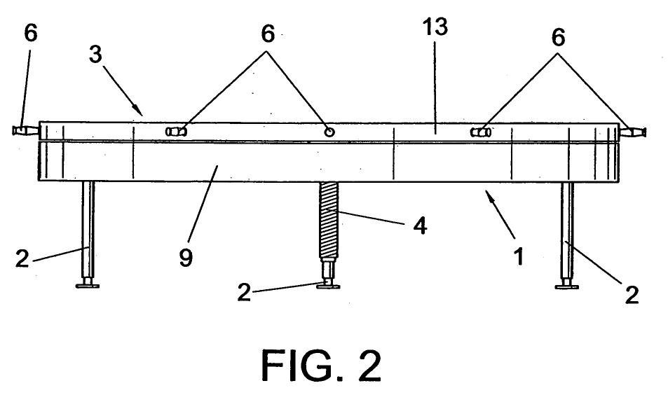

FIG. 3.—Represents a view in exploded perspective of the grill of the invention referred to in the previous figures but showing some accessories which can be coupled thereto.

### DESCRIPTION OF THE PREFERRED FORM OF EMBODIMENT

Considering the numbering adopted in the figures, the grill for cooking is defined starting from a lower base 1 with support legs 2 on the ground which are adjustable in height and an upper grating 3 which includes a threaded rod 4 in its center for facilitating its coupling in a central hole 5 of the base 1, in such a way that the grating 3 will be able to be made to turn in one direction or the other in order to vary its height in the case of a threaded rod, these turns not being necessary since this system rises or descends by means of mechanical action, and thereby bring it closer to or further away from the embers located on the ground beneath the lower base 1, thus obtaining greater or lesser heat for the products to be cooked that are borne on the grating 3.

The rotation of the grating 3 will be carried out by means of some radial handles 6 projecting from the edge of said grating 3.

Both the lower base 1 and the grating 3 possess a configuration that is circular, hexagonal, octagonal, etc., which facilitates their handling both during their use and when they are being assembled and dismantled, and also while they are being handled for transportation, in such a way that in this case the grating 3 and the lower base 1 will be arranged separately in vertical planes and their movement will be done with the minimum effort by carrying out turns on the grill and base by means of a bearing.

The lower base 1 includes radial arms 7 which project from a central body 8 where the threaded hole 5 is located and end in an outer circumferential ring 9. The base is furthermore reinforced by means of two polygonal configurations 10 which are attached to the radial arms 7. The support legs 2 project from the zone where the radial arms 7 meet the sections of the outermost polygonal configuration 10.

The grating 3 includes a central body 11 from where some radial arms 12 project which are attached via their ends to an outer circumferential ring 13, there existing other concentric rings 14 of smaller diameter which are also attached to the radial arms 12.

The threaded rod 4 projects from the central body 11 of the grating 3.

Provision has furthermore been made for at least one flat piece in the form of a circular sector 15 for being coupled on the grating 3 with application as use. for cutting food.

Another possibility is the incorporation of other pieces in the form of a circular sector 15′ like a small and thicker grating for arranging smaller products than those that rest on the grating 3.

Moreover, there is also the possibility of the threaded rod being integral with the lower base, with which the complementary threaded hole would then be located in the central body of the grating.

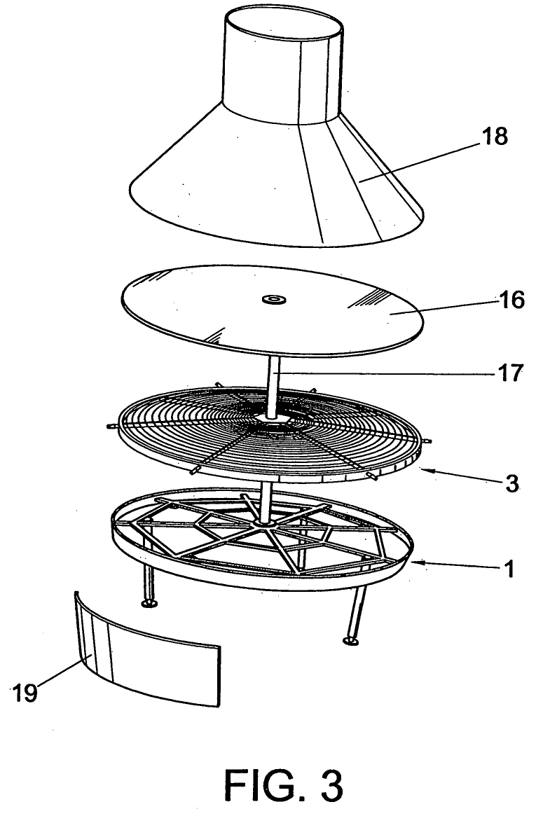

In the present embodiment of the invention, the grill has some accessories, one of which consists of an additional upper disc 16 that can be attached to the rest of the grill by means of a central bar 17 and which permits food to be kept hot while the cooking is continued on the grating 3, as shown in FIG. 3. This upper disc 16 has a diameter less than or equal to that of the said grating 3.

Provision has also been made for another accessory consisting of a hood 18 which facilitates the extraction of smoke and prevents particles in the air from falling onto the food, this hood 18 being shown in FIG. 3.

A further accessory has moreover been provided, also shown in FIG. 3, consisting of a lateral screen 19 running from part of the perimeter of the lower base 1 as far as ground, being situated in a zone where the air reaches from the outside, thereby permitting the cook to be protected from the heat.

1. GRILL FOR COOKING which, being intended for grilling meat and other products, and for making paellas and any other dishes with the aid of a receptacle, is characterized in that it comprises a lower base (1) with legs (2) and an upper grating (3) which can be regulated in height and which bears the different foods to cook, the upper grating (3) being attached to the lower base (1) via some means that permit its height to be varied at any moment in order to obtain a greater or lesser amount of heat for the products being cooked.

2. GRILL FOR COOKING according to claim 1, characterized in that the means of attachment between the grating and the base consist of a central threaded rod which screws into a complementary hole, in such a way that when the grating is rotated in one direction or the other it rises or descends, moving further away from or closer to the embers that produce the heat for cooking the food.

3. GRILL FOR COOKING according to claim 2, characterized in that the threaded rod (4) is integral with a central body (11) of the grating (3), while the complementary hole (5) into which the said thread (4) screws is located in another central body (8) of the lower base (1).

4. GRILL FOR COOKING according to claim 2, characterized in that the threaded rod is integral with a central body (8) of the lower base (1), while the complementary hole into which that thread screws is 30 located in the central body (11) of the grating (3).

5. GRILL FOR COOKING according to claim 1, characterized in that it incorporates at least one piece which is seated complementarily in a zone of the grating (3) with complementary recesses which ensure a stable and immovable position for said piece.

6. GRILL FOR COOKING according to claim 5, characterized in that the piece which is seated complementarily on the grating (3) comprises a flat structure (15) in order to facilitate cutting the food.

7. GRILL FOR COOKING according to claim 5, characterized in that the piece which is seated complementarily on the grating (3) comprises a grating structure that is thicker (15′) than the grating on which it rests.

8. GRILL FOR COOKING according to claim 1, characterized in that the grating (3) incorporates at least one radial handle (6) which projects from the perimetric edge or contour of said grating (3) as a comfortable means of handling for its rotation.

9. GRILL FOR COOKING according to claim 1, characterized in that the grating (3) comprises a structure formed from radial arms (12) which project from the central body (11) and are attached via their diverging ends to an outer circumferential ring (13), there existing other concentric rings (14) of smaller diameter.

10. GRILL FOR COOKING according to claim 1, characterized in that its lower base (1) comprises some radial arms (7) which project from the central body (8) and are attached via their diverging ends to a circumferential ring (9), the base (1) furthermore including sections of bar which are attached to the radial arms (7) in polygonal formations (10).

11. GRILL FOR COOKING according to claim 10, 30 characterized in that the legs (2) project from the point where the polygonal sections of bar (10) meet the radial arms (7).

12. GRILL FOR COOKING according to claim 1, characterized in that the legs (2) are adjustable in height, the grill being able to be kept completely horizontal on uneven ground for its perfect functioning or movement of the food.

13. GRILL FOR COOKING according to claim 1, characterized in that it comprises an accessory constituted by an additional upper disc (16) that can be attached to the rest of the grill by means of a central bar (17) and which permits food to be kept hot while the cooking is continued on the grating (3).

14. GRILL FOR COOKING according to claim 13, characterized in that this upper disc (16) has a diameter 10 less than or equal to the one of the grating (3).

15. GRILL FOR COOKING according to claim 1, characterized in that it comprises an accessory constituted by a hood (18) which facilitates the extraction of smoke and prevents particles in the air from falling onto the food.

16. GRILL FOR COOKING according to claim 1, characterized in that it includes an accessory constituted by a lateral screen (19) running from part of the perimeter of the lower base (1) until the ground, being situated in a zone where the air reaches from the outside, thereby permitting the cook to be protected from the heat.
